(19) United States
(12) Patent Application Publication
(10) Pub. No.: US 2006/0168329 A1
(43) Pub. Date: Jul. 27, 2006

(54) Apparatus and method for acceleration of electronic message processing through pre-filtering

(75) Inventors: Teewoon Tan, Roseville (AU); Darren Williams, Newtown (AU); Robert Matthew Barrie, Double Bay (AU); Stephen Gould, Killara (AU); Craig Cameron, Forrest (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sensory Networks, Inc., Palo Alto, CA (US)

(21) Appl. No.: 11/291,512

(22) Filed: Nov. 30, 2005

Related U.S. Application Data
(60) Provisional application No. 60/632,240, filed on Nov. 30, 2004.

(51) Int. Cl. G06F 15/173

(52) U.S. Cl. 709/238

(57) ABSTRACT

A classifier of electronic messages includes one or more pre-filters and a filter. Messages classified as spam or legitimate by one or more of the pre-filters bypass the filter. Messages classified as suspicious are further classified by the filter as either spam or legitimate. Messages classified as spam are routed to a spam quarantine storage area. Messages classified as legitimate are routed to a spam delivery area.

### CROSS-REFERENCES TO RELATED APPLICATIONS

The present application claims benefit under 35 USC 119(e) of U.S. provisional application No. 60/632240, file Nov. 30, 2004, entitled “Apparatus and Method for Acceleration of Security Applications Through Pre-Filtering”, the content of which is incorporated herein by reference in its entirety.

The present application is also related to copending application Ser. No. ______, entitled “Apparatus And Method For Acceleration Of Security Applications Through Pre-Filtering”, filed contemporaneously herewith, attorney docket no. 021741-001810US; copending application serial number , entitled “Apparatus And Method For Acceleration Of Malware Security Applications Through Pre-Filtering”, filed contemporaneously herewith, attorney docket no. 021741-001830US; copending application Ser. No. ______, entitled “Apparatus And Method For Accelerating Intrusion Detection And Prevention Systems Using Pre-Filtering”, filed contemporaneously herewith, attorney docket no. 021741-001840US; all assigned to the same assignee, and all incorporated herein by reference in their entirety.

### BACKGROUND OF THE INVENTION

The present invention relates generally to the area of processing electronic messages. More specifically, the present invention relates to systems and methods for classifying electronic messages before their delivery.

In the last many years, the Internet has changed from a research network to a ubiquitous communication medium that enables a diverse range of useful applications, including electronic mail, instant messaging and internet telephony. Within the USA, the amount of Internet data traffic surpassed that of voice traffic several years ago and continues to grow rapidly, approximately doubling every year since 1997. The total number of unsolicited electronic messages being sent over the internet has also grown dramatically and now, in many networks, exceeds the total number of legitimate messages. These unsolicited electronic messages are commonly called spam. In the case of instant messaging, spam is also referred to as spim and in the case of internet telephony, spam is also referred to as spit.

The content of spam is both diverse and dynamic. Common spam messages include advertisements for products and services, pornography and phishing scams. Unlike commercial postal mail, the sending of electronic messages is relatively cheap for the sending party such that millions of electronic messages can be feasibly sent by an individual every day. If only a very small fraction of recipients reply, the cost of sending is more than recouped, resulting in large potential profits for spammers. In addition, spam is used as a transport for viruses, worms and Trojan horses such that computers often become spam sources themselves after receiving infected spam.

The transmission and reception of increasingly large amounts of spam has several important consequences. Firstly, separating legitimate messages and spam messages after delivery is a time consuming process and may nullify any productivity benefit gained through the sending of electronic messages. Secondly, infrastructures for processing electronic messages may not be able to handle the increased number of messages and therefore may require constant upgrading to maintain adequate speeds.

FIG. 1A depicts a prior art electronic message filtering system. Input message 110 is classified by spam filter 120 into two categories. The first category is legitimate. Messages classified as legitimate by spam filter 120 are routed to message delivery storage area 140. The second category is spam. Messages classified as spam by spam filter 120 are routed to spam quarantine storage area 130.

FIG. 1B depicts a prior art electronic message filtering system integrated with a mail processing appliance. Message 110 is sent from message source 150 across transmission medium 160 to mail processing appliance 170. Received message 110 is buffered by mail processing appliance 170. A copy of received message 110 is routed to spam filter 180. Spam filter 180 classifies the copy of message 110 as either legitimate or spam. The classification is communicated to mail processing appliance 170. Messages classified as legitimate by spam filter 180 are routed to message delivery storage area 140. Messages classified as spam by spam filter 180 are routed to spam quarantine storage area 130.

In recognition of the need to reduce the harmful effects of spam, the sending of spam is now illegal in several countries. Nevertheless, the amount of spam continues to increase, resulting in increased loads on message processing systems. The electronic message filtering systems of FIG. 1A and FIG. 1B are slow and unable to handle large quantities of messages.

There is a need for a system and methodology to increase the speed of classifying electronic messages as spam or legitimate during the delivery process, such that these increased loads can be effectively handled and the delivery of spam to end users can be minimized.

### BRIEF SUMMARY OF THE INVENTION

In accordance with the present invention electronic messages are classified before they are delivered to their destinations. In one embodiment, the present invention includes, in part, a first filtering stage configured to classify input messages into several types. Messages classified as the third type by the first filtering stage are routed to other filtering stages for further classification as one of the first and second types. In some embodiments, first, second and third types are respectively spam, legitimate and suspicious. In one embodiment, the speed of the first filtering stage is greater than the speed of subsequent stages. Messages classified by the first filtering stage as being of the first or second type bypass other filtering stages to accelerate the processing of the received electronic messages.

### BRIEF DESCRIPTION OF THE DRAWINGS

The accompanying drawings, which are incorporated in and constitute a part of this specification, illustrate exemplary embodiments of the invention and together with the description, serve to explain the principles of the invention.

FIG. 1A depicts a prior art electronic message classification system.

FIG. 1B depicts a prior art electronic message classification system integrated with a mail processing appliance.

FIG. 2 shows logical blocks of an electronic message classification system, in accordance with an embodiment of the present invention.

FIG. 3 shows logics blocks of an electronic message classification system, in accordance with another embodiment of the present invention,

FIG. 4 shows logical blocks of an electronic message classification system, in accordance with another embodiment of the present invention.

FIG. 5 shows logical blocks of an electronic message classification system, in accordance with another embodiment of the present invention.

FIG. 6 shows logical blocks of an electronic message classification system, in accordance with another embodiment of the present invention.

FIG. 7 shows logical blocks of an electronic message classification system in which the spam pre-filter outputs metadata in accordance with an embodiment of the present invention.

FIG. 8 shows logical blocks of an electronic message classification system in which the spam pre-filter appends metadata to the electronic message, in accordance with an embodiment of the present invention.

FIG. 9 shows a number of blocks of an electronic message classification system integrated with a mail processing appliance in accordance with an embodiment of the present invention.

FIG. 10 shows a number of blocks of an electronic message classification system integrated with a mail processing appliance in accordance with another embodiment of the present invention.

### DETAILED DESCRIPTION OF THE INVENTION

Exemplary embodiments of the present invention are now described in detail. In the drawings, like numbers indicate like blocks. As used herein, the meaning of “a”, “an”, and “the” includes plural reference, unless the context clearly dictates otherwise. Finally, as used herein, the meanings of “and” and “or” include both the conjunctive and disjunctive and may be used interchangeably unless the context clearly dictates otherwise.

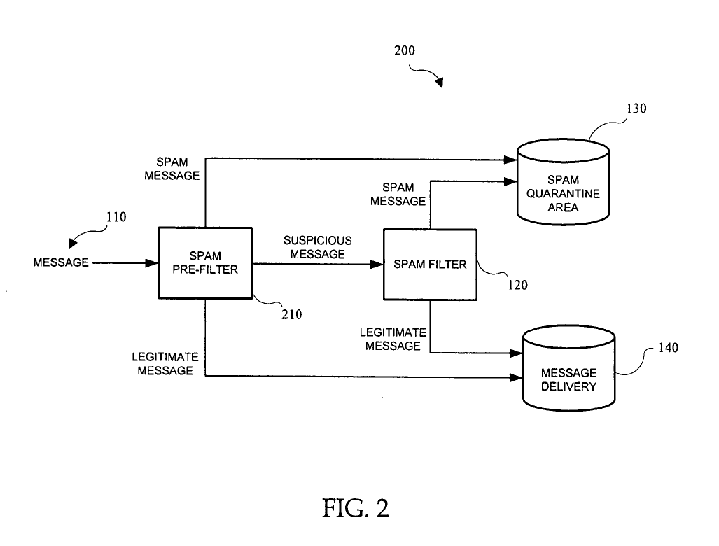

FIG. 2 shows various logical blocks of a mail classification system 200 in accordance with an exemplary embodiment of the present invention. Electronic message classification system 200 is shown as including a spam pre-filter 210 that classifies input message 110 into three categories. The first category includes legitimate messages. Messages classified as legitimate by spam pre-filter 210 bypass spam filter 120 and are routed to message delivery storage area 140. The second category includes spam messages. Messages classified as spam by spam pre-filter 210 bypass spam filter 120 and are routed to spam quarantine storage area 130. The third category includes suspicious messages. Messages classified as suspicious by spam pre-filter 210 are routed to spam filter 120 for further classification.

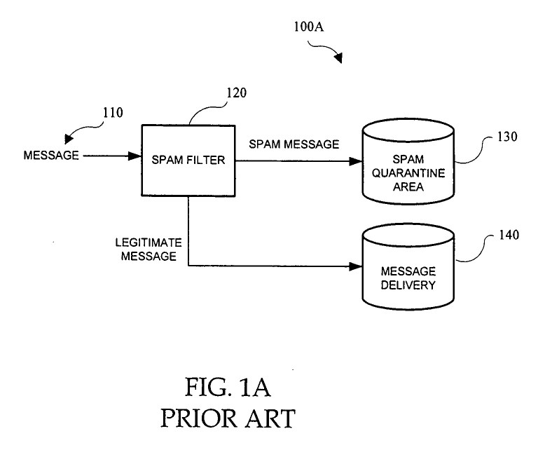

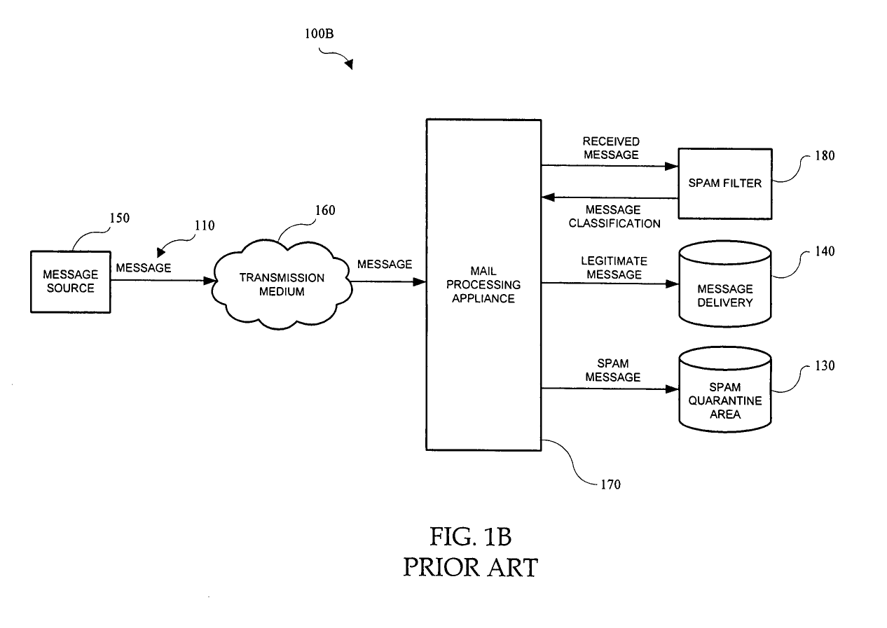

Through the addition of a spam pre-filter, higher throughputs can be achieved in comparison with prior art single stage spam filter of FIG. IA. The proportion of messages classified as either spam or legitimate by spam pre-filter 210 is called the bypass rate. The classified messages need not be further classified by spam filter 120. As the bypass rate increases, fewer messages need to be classified by spam filter 120. In the present invention, spam pre-filter 210 is sufficiently fast such that the speed of filtering messages is faster than the prior art single stage spam filter system of FIG. IA. For example, if ninety percent of input messages 110 are classified by spam pre-filter 210 as either legitimate or spam messages and thus bypass spam filter 110, electronic message classification system 200 operates at a processing speed of, for example, ten times the processing speed shown in FIG. 1A. In addition, in some embodiments, spam filter 120 does not require modification such that filtering speed can be increased in pre-existing prior-art systems with minimal integration effort.

In an embodiment, the spam pre-filter 210 classifies electronic messages by using rules to search for distinctive patterns within electronic messages and processing any corresponding matches. In some embodiments, rules to be matched include literals and regular expression patterns. Each pattern has a numeric weight. The weights of all matches within a message are combined to give a score. Messages are classified by comparing said score with two thresholds: first threshold and second threshold. A message with a score less than the first threshold is classified as legitimate. A message with a score greater than the first threshold and less than the second threshold is classified as suspicious. A message with a score greater than the second threshold is classified as spam.

In some embodiments, the matching of rules is done by dedicated pattern-matching hardware such as those disclosed in U.S. patent application No. US 2005/0114700, the content of which is incorporated herein by reference in its entirety.

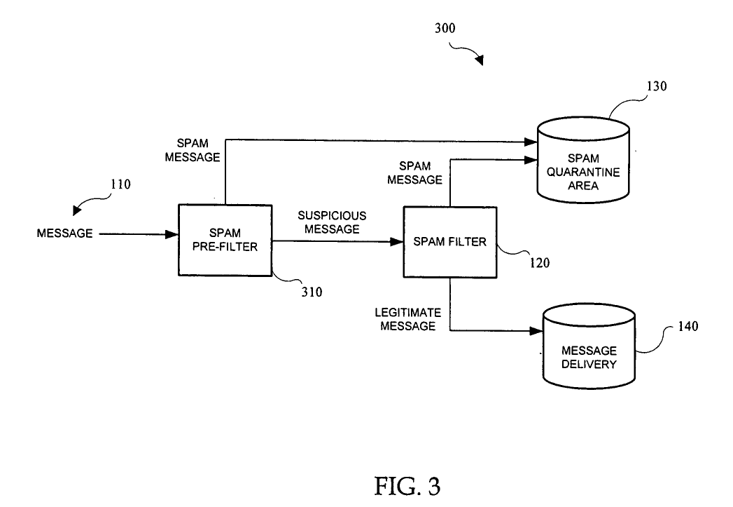

FIG. 3 shows various logical blocks of an electronic message classification system 300 in accordance with another exemplary embodiment of the present invention. Spam pre-filter 310 classifies input messages 110 into two categories. The first category includes spam messages. Messages classified as spam by spam pre-filter 310 bypass spam filter 120 and are routed to spam quarantine storage area 130. The second category includes suspicious messages. Messages classified as suspicious by spam pre-filter 310 are routed to spam filter 120 for further classification.

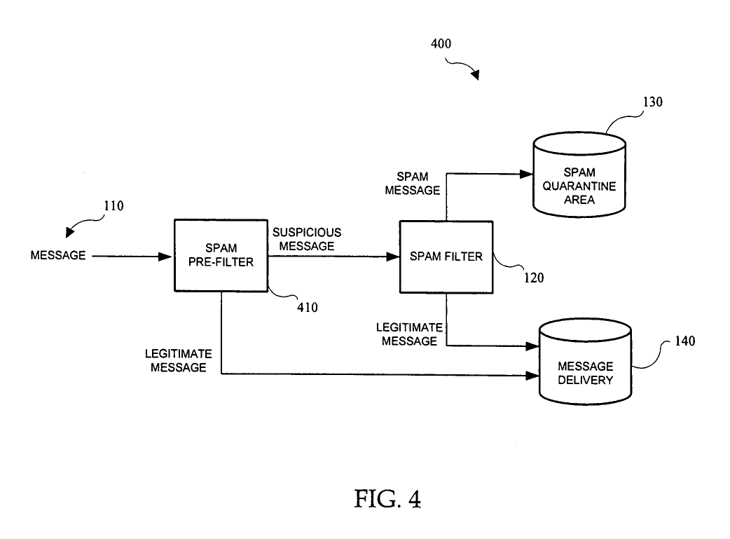

FIG. 4 shows various logical blocks of an electronic message classification system 400 in accordance with another exemplary embodiment of the present invention. Spam pre-filter 410 classifies input messages 110 into two categories. The first category includes legitimate messages. Messages classified as legitimate by spam pre-filter 410 bypass spam filter 120 and are routed to message delivery storage area 140. The second category includes suspicious messages. Messages classified as suspicious by spam pre-filter 410 are routed to spam filter 120 for further classification.

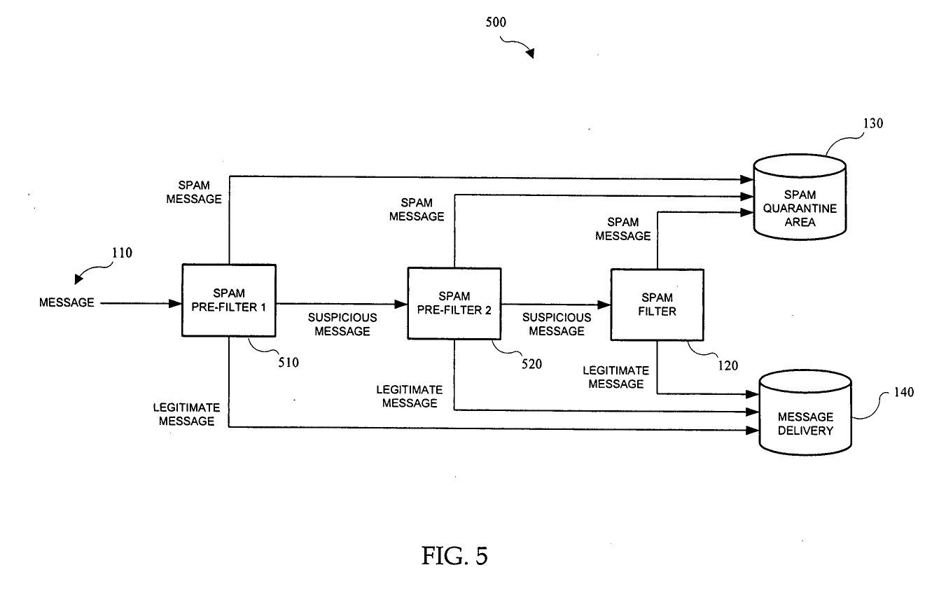

A multitude of spam pre-filters can be used together in a chained arrangement, in accordance with the present invention. FIG. 5 shows various logic blocks diagram of an electronic message classification system 500 of one such embodiment. First spam pre-filter 510 classifies input messages 110 into three categories. The first category includes legitimate messages. Messages classified as legitimate by first spam pre-filter 510 bypass both second spam pre-filter 520 and spam filter 120 and are routed to message delivery storage area 140. The second category includes spam messages. Messages classified as spam by first spam pre-filter 510 bypass both second spam pre-filter 520 and spam filter 120 and are routed to spam quarantine storage area 130. The third category includes suspicious messages. Messages classified as suspicious by first spam pre-filter 510 are routed to second spam pre-filter 520 for further classification. Second spam pre-filter 520 further classifies suspicious messages from first spam pre-filter 510 in three categories. The first category includes legitimate messages. Messages classified as legitimate by second spam pre-filter 520 bypass spam filter 120 and are routed to message delivery storage area 140. The second category includes spam messages. Messages classified as spam by second spam pre-filter 520 bypass spam filter 120 and are routed to spam quarantine storage area 130. The third category includes suspicious messages. Messages classified as suspicious by second spam pre-filter 520 are routed to spam filter 120 for further classification.

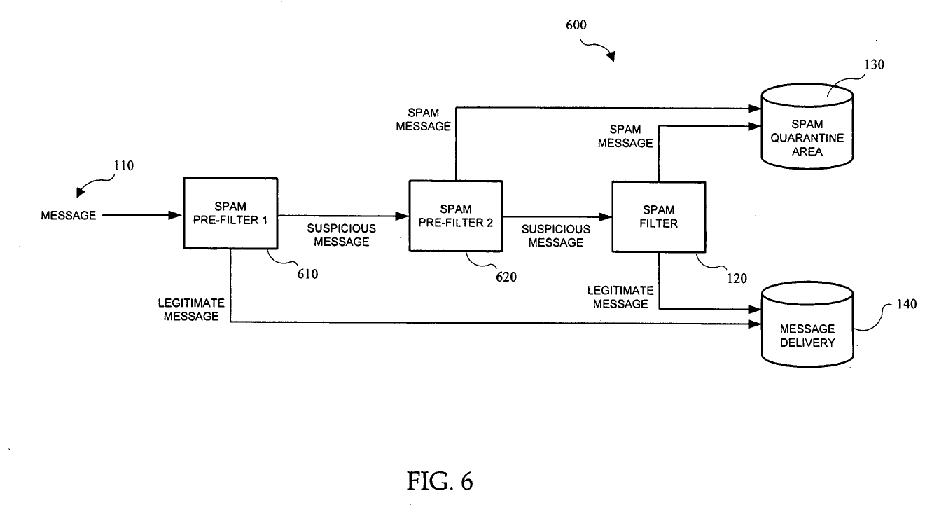

FIG. 6 shows an electronic message classification system 600 in which a multitude of spam pre-filters are used in a chained arrangement in accordance with another embodiment of the present invention. First spam pre-filter 610 classifies input messages 110 into two categories. The first category includes legitimate messages. Messages classified as legitimate by first spam pre-filter 610 bypass second spam pre-filter 620 and spam filter 120 and are routed to message delivery storage area 140. The second category includes suspicious messages. Messages classified as suspicious by first spam pre-filter 610 are routed to second spam pre-filter 620 for further classification. Second spam pre-filter 620 further classifies suspicious messages from first spam pre-filter 610 in two categories. The first category includes spam messages. Messages classified as spam by second spam pre-filter 620 bypass spam filter 120 and are routed to spam quarantine storage area 130. The second category includes suspicious messages. Messages classified as suspicious by second spam pre-filter 620 are routed to spam filter 120 for further classification.

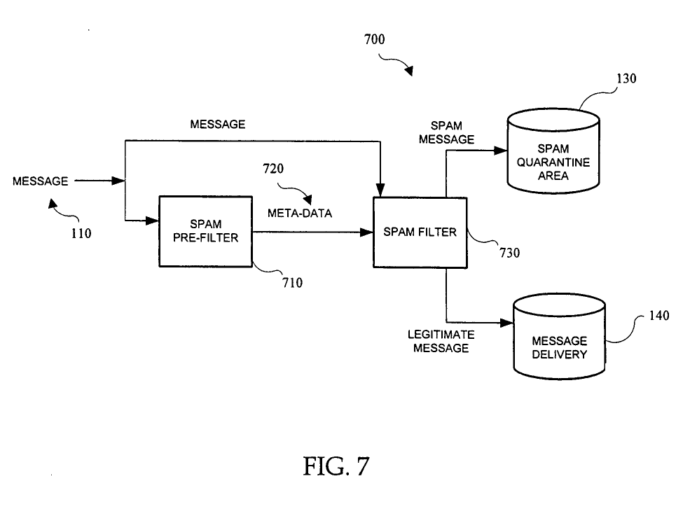

FIG. 7 shows logical blocks of an electronic message classification system 700 in accordance with another embodiment of the present invention. Spam pre-filter 710 classifies input message 110 into one or more categories. The classification result is routed to spam filter 730 in a separate data message 720, commonly known to those skilled in the art as meta-data. Spam filter 730 receives both meta-data 720 and message 110 and classifies message 110 into two categories: spam and legitimate. In an embodiment, meta-data 720 may include the location of pattern matches within message 110, a numeric score and an encoded form of the classification result as determined by spam pre-filter 710.

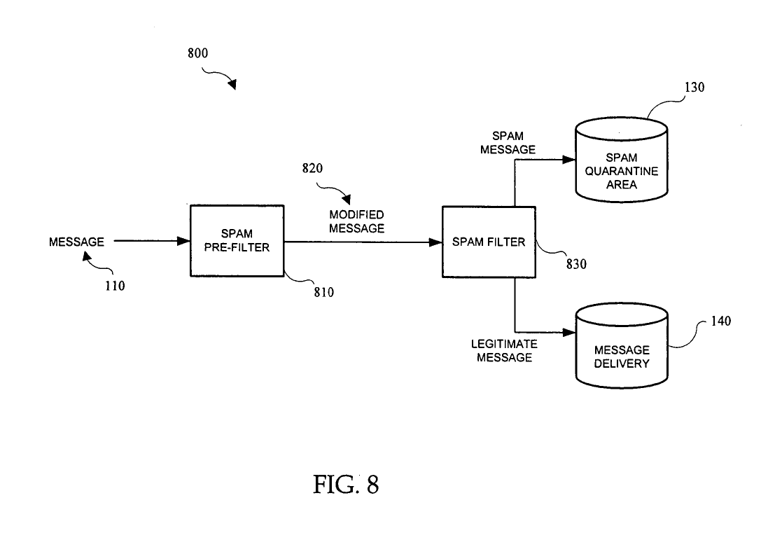

FIG. 8 shows logic blocks of an electronic message classification system 800 in accordance with another embodiment of the present invention. In this embodiment, spam pre-filter 810 modifies message 110 before routing modified message 820 to spam filter 830. Spam pre-filter 810 classifies message 110 into one or more categories. Message 110 is modified to include an encoded form of the classification result. Spam filter 830 receives modified message 820 and classifies modified message 820 into two categories: spam and legitimate. In an embodiment, the modification of spam pre-filter 810 is reversed and original message 110 routed to spam quarantine storage area 130 if classified as spam by spam filter 830, or routed to message delivery storage area 140 if classified as legitimate by spam filter 830. In another embodiment, modified message 820 is routed to spam quarantine storage area 130 if classified as spam by spam filter 830, and modified message 820 is routed to message delivery storage area 140 if classified as legitimate by spam filter 830.

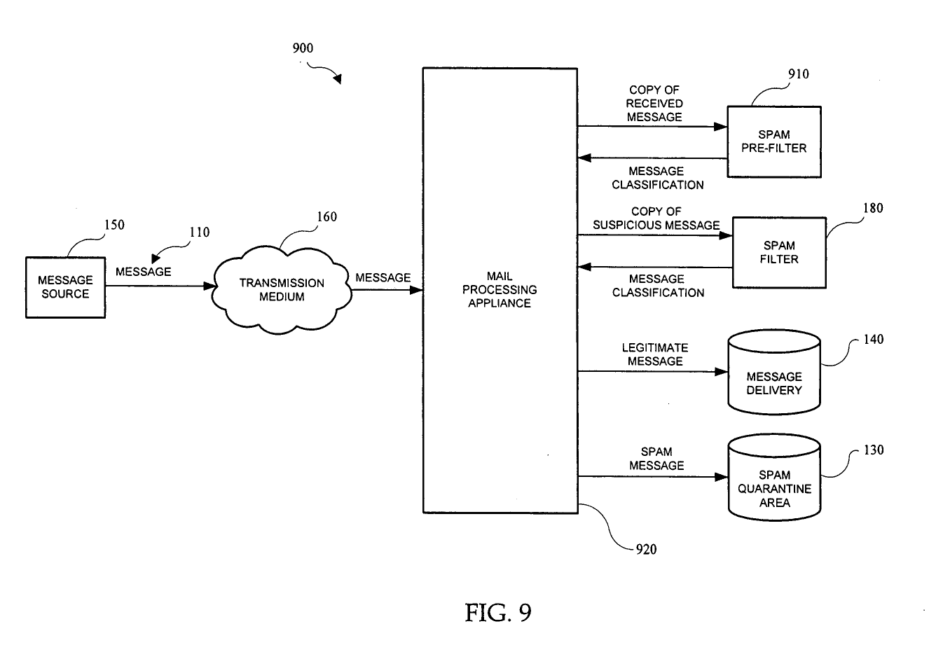

FIG. 9 shows logic blocks of an electronic message classification system 900 adapted to include a mail processing appliance, such as a Mail Transfer Agent (MTA), in accordance with another embodiment of the present invention. A message 110 is sent from message source 150 across transmission medium 160 to mail processing appliance 920. In an embodiment, transmission medium 160 may include the Internet, an Ethernet network, wireless network, or a local bus within a computer system. The received message 110 is buffered by mail processing appliance 920. A copy of the received message is routed to spam pre-filter 910. Spam pre-filter 910 classifies the message into one or more categories and routes the classification result to mail processing appliance 920. In an embodiment, spam pre-filter 910 classifies the message into two categories. The first category includes legitimate messages. Messages classified as legitimate by spam pre-filter 910 bypass spam filter 180 and are routed to message delivery storage area 140 by mail processing appliance 920. The second category includes suspicious messages. Messages classified as suspicious by spam pre-filter 910 are routed to spam filter 180 for further classification. In another embodiment, spam pre-filter 910 classifies the message into two categories. The first category includes spam messages. Messages classified as spam by spam pre-filter 910 bypass spam filter 180 and are routed to spam quarantine storage area 130 by mail processing appliance 920. The second category includes suspicious messages. Messages classified as suspicious by spam pre-filter 910 are routed to spam filter 180 for further classification. In another embodiment, spam pre-filter 910 classifies the message into three categories. The first category includes spam messages. Messages classified as spam by spam pre-filter 910 bypass spam filter 180 and are routed to spam quarantine storage area 130 by mail processing appliance 920. The second category includes legitimate messages. Messages classified as legitimate by spam pre-filter 910 bypass spam filter 180 and are routed to message delivery storage area 140 by mail processing appliance 920. The third category includes suspicious messages. Messages classified as suspicious by spam pre-filter 910 are routed to spam filter 180 for further classification.

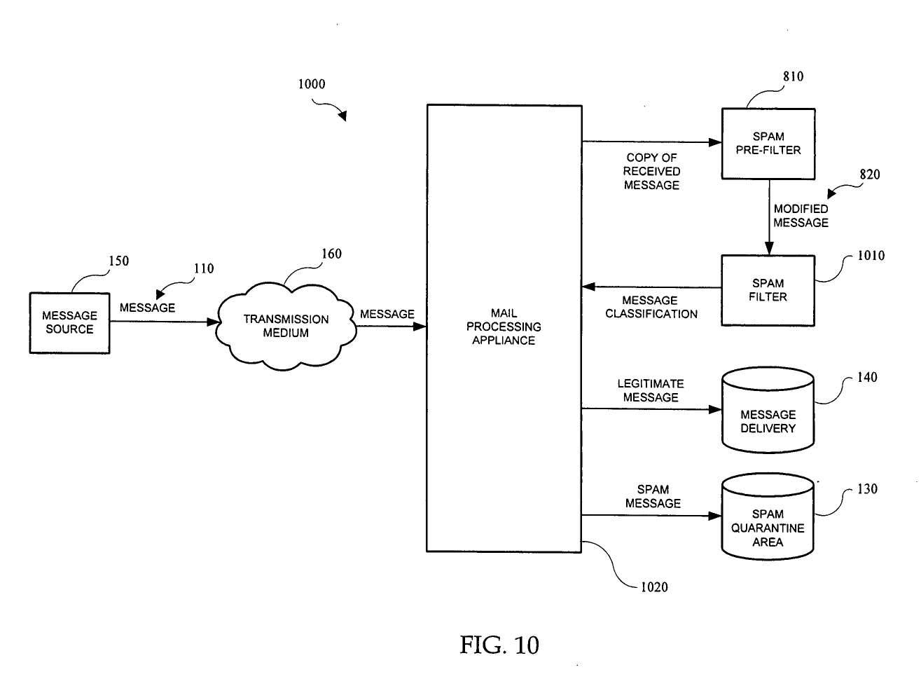

FIG. 10 shows logic blocks of an electronic message classification system 1000 adapted to include a mail processing appliance, such as a Mail Transfer Agent (MTA), in accordance with another embodiment of the present invention. A message 110 is sent from message source 150 across transmission medium 160 to mail processing appliance 1020. The received message 110 is buffered by mail processing appliance 1020. A copy of the received message is routed to spam pre-filter 810. Spam pre-filter 810 classifies copy of received message into one or more categories and modifies the message to include an encoded form of the classification result. Spam filter 1010 receives modified message 820 and classifies the modified message 820 into two categories: spam and legitimate. The message classification result is routed to mail processing appliance 1020. Mail processing appliance 1020 retrieves the buffered message. Messages classified as spam by the combination of spam filter 1010 and spam pre-filter 810 are routed to spam quarantine storage area 130 by mail processing appliance 1020. Messages classified as legitimate by the combination of spam filter 1010 and spam pre-filter 810 are routed to message delivery storage area 140 by mail processing appliance 1020.

The above embodiments of the present invention are illustrative and not limitative. Various alternatives and equivalents are possible. For example, the invention is not limited by the type of filter-chain topology used. Furthermore, the rules may be derived from other well-defined languages; spam messages may be deleted immediately after classification and messages may be divided into message parts, with each part passing through a different combination of spam pre-filters and spam filters. Moreover, the described data flow of this invention may be implemented within separate network of computer systems, or in a single network system, and running either as separate applications or as a single application. The invention is not limited by the type of integrated circuit in which the present disclosure may be disposed. Nor is the disclosure limited to any specific type of process technology, e.g., CMOS, Bipolar, or BICMOS that may be used to manufacture the present disclosure. Other additions, subtractions or modifications are obvious in view of the present disclosure and are intended to fall within the scope of the appended claims

What is claimed is:

1. A message filtering system comprising:
a first filtering stage configured to receive and classify a message as one of at least first, second or third message types, wherein said message is routed to a first storage area if classified as being of the first type, and wherein said message is routed to a second storage area if classified as being of the second type; and
a second filtering stage configured to receive the message if the message is classified as being of the third type.

2. The message filtering system of claim 1 wherein said message is routed to said first storage area if the second filtering stage classifies said message as being of the first type, and wherein said message is routed to said second storage area if the second filtering stage classifies said message as being of the second type.

3. The message filtering system of claim 1 wherein the speed of first filtering stage is greater than the speed of second filtering stage.

4. The message filtering system of claim 1 wherein the first filtering stage classifies messages by matching rules.

5. The message filtering system of claim 4 wherein said rules comprise literals.

6. The message filtering system of claim 5 wherein a number of said literals is greater than 1,000.

7. The message filtering system of claim 4 wherein said rules comprise regular expressions.

8. The message filtering system of claim 1 wherein said first message type includes legitimate messages and said first storage area is a legitimate message delivery storage.

9. The message filtering system of claim 8 wherein said second message type includes spam messages and said second storage area is a spam message delivery storage.

10. The message filtering system of claim 9 wherein said third message type includes suspicious messages.

11. The message filtering system of claim 10 wherein said second filtering stage is further configured to classify the suspicious messages as either spam messages or legitimate messages.

12. The message filtering system of claim 10 wherein said second filtering stage is further configured to classify the suspicious messages as either spam messages, legitimate messages, or suspicious messages.

13. The message filtering system of claim 12 further comprising:
a third filtering stage configured to receive the suspicious messages from the second filtering stage and classify the received suspicious messages as either spam messages or legitimate messages.

14. A message filtering system comprising:
a first filtering stage configured to receive and classify a message as one of at least legitimate or suspicious message, wherein said received message is routed to a first storage area if classified as being a legitimate message, and
a second filtering stage configured to receive the message if the message is classified as being a suspicious message.

15. The message filtering system of claim 14 wherein said second filtering stage is further configured to classify the suspicious message it receives as either a spam or a legitimate message.

16. The message filtering system of claim 15 wherein said message is routed to said first storage area if the second filtering stage classifies said message as being a legitimate message, and wherein said message is routed to said second storage area if the second filtering stage classifies said message as being a spam message.

17. A message filtering system comprising:
a first filtering stage configured to receive and classify a message as one of at least legitimate or suspicious message, wherein said received message is routed to a first storage area if classified as being a legitimate message;
a second filtering stage configured to receive the suspicious message from the first filtering stage and classify the received suspicious message as a spam message or a suspicious message; and
a third filtering stage configured to receive the suspicious message from the second filtering stage and classify the received suspicious message as a spam message or a legitimate message.

18. A message filtering system comprising:
first and second filtering stages each adapted to receive a message, wherein said first filtering stage generates metadata in response to the received message and supplies the metadata to the second filtering stage, said second filtering stage is further configured to receive said metadata and said message and classify the received message as being one of spam message or legitimate message.

19. A message filtering system comprising:
a first filtering stage configured to receive and modify a message to supply a modified message; and
a second filtering stage configured to receive and classify the modified message as either a spam message or a legitimate message.

20. The system of claim 19 wherein said first filtering stage further comprises:
a security device configured to perform security processing, the security device includes one or more hardware logic, wherein said hardware logic is configured to perform high speed data processing

21. The system of claim 20 wherein said hardware logic is reconfigurable

22. A method of filtering messages, the method comprising:
receiving and classifying a message as one of at least first, second or third message types;
routing said message to a first storage area if the message is classified as being of the first type;
routing said message to a second storage area if the message is classified as being of the second type; and
further classifying the message if the message is previously classified as being of the third type.

23. The method of claim 22 further comprising:
receiving a message previously classified as being of the third type;
classifying said message as one of at least first or second type;
routing said message to a first storage area if the message is classified as being of the first type; and
routing said message to a second storage area if the message is classified as being of the second type.

24. The method of claim 22 wherein the messages are classified by matching rules.

25. The method of claim 24 wherein said matching rules comprise literals.

26. The method of claim 25 wherein a number of said literals is greater than 1,000.

27. The method of claim 24 wherein said matching rules comprise regular expressions.

28. The method of claim 22 wherein said first message type includes legitimate messages and said first storage area is a legitimate message delivery storage.

29. The method of claim 22 wherein said second message type includes spam messages and said second storage area is a spam message delivery storage.

30. The method of claim 29 wherein said third message type includes suspicious messages.

31. The method of claim 30 wherein said suspicious messages are further classified as either spam messages or legitimate messages.

32. The method of claim 22 further comprising:
receiving a message previously classified as being of the third type;
classifying said message as one of at least first, second or third type;
routing said message to a first storage area if the message is classified as being of the first type;
routing said message to a second storage area if the message is classified as being of the second type; and
further classifying the message if the-message is previously classified as being of the third type.

33. A method of filtering messages, the method comprising:
receiving and classifying a message as one of at least first or third message types;
routing said message to a first storage area if the message is classified as being of the first type;
further classifying the message if the message is previously classified as being of the third type.

34. The method of claim 33 further comprising:
receiving a message previously classified as being of the third type;
classifying said message as one of at least first or second type;
routing said message to a first storage area if the message is classified as being of the first type; and
routing said message to a second storage area if the message is classified as being of the second type.

35. A method of filtering messages, the method comprising:
receiving and classifying a message as one of at least second or third message types;
routing said message to a second storage area if the message is classified as being of the second type; and
further classifying the message if the message is previously classified as being of the third type.

36. The method of claim 35 further comprising:
receiving a message previously classified as being of the third type;
classifying said message as one of at least first or second type;
routing said message to a first storage area if the message is classified as being of the first type; and
routing said message to a second storage area if the message is classified as being of the second type.

37. A method of filtering messages, the method comprising:
receiving and classifying a message as one of at least first or third message types;
routing said message to a first storage area if the message is classified as being of the first type; and
further classifying the message if the message is previously classified as being of the third type.

38. The method of claim 37 further comprising:
receiving a message previously classified as being of the third type;
classifying said message as one of at least second or third type;
routing said message to a second storage area if the message is classified as being of the second type; and
further classifying the message if the message is previously classified as being of the third type.

39. The method of claim 38 further comprising:
receiving a message previously classified as being of the third type;
classifying said message as one of at least first or second type;
routing said message to a first storage area if the message is classified as being of the first type; and
routing said message to a second storage area if the message is classified as being of the second type.

40. A method of filtering messages, the method comprising:
receiving a message; and
generating metadata in response to said received message.

41. The method of claim 40 further comprising:
receiving a message and metadata;
classifying said message using said metadata as one of at least first or second type;
routing said message to a first storage area if the message is classified as being of the first type; and
routing said message to a second storage area if the message is classified as being of the second type.

42. A method of filtering messages, the method comprising:
receiving a message; and
generating modified message in response to said received message.

43. The method of claim 42 further comprising:
receiving a modified message;
classifying said modified message as one of at least first or second type;
routing said message to a first storage area if the message is classified as being of the first type; and
routing said message to a second storage area if the message is classified as being of the second type.
